(19) United States
(12) Patent Application Publication
(10) Pub. No.: US 2006/0232589 A1
(43) Pub. Date: Oct. 19, 2006

(54) Uninterrupted execution of active animation sequences in orphaned rendering objects

(75) Inventor: Christopher A. Glein, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/219,199

(22) Filed: Sep. 2, 2005

Related U.S. Application Data
(60) Provisional application No. 60/673,044, filed on Apr. 19, 2005.

(51) Int. Cl. G06T 15/70

(52) U.S. Cl. 345/473

(57) ABSTRACT

An animation model is disclosed for generating animations that may be associated with one or more user interfaces utilized by executing software applications. The animations may be activated responsive to one or more events during software execution, such as when associated user interfaces may be initially generated for display or when the user interfaces may be disposed of. Further, the animations may be configured to modify one or more properties of the user interface, including position, size, scale, rotation, opacity and/or color. The animation model may also enable active animations associated with user interfaces disposed of during software execution to continue animating despite their discarded state.

### PRIORITY CLAIM

This application claims the benefit of U.S. Provisional Patent Application Ser. No. 60/673,044 filed on Apr. 19, 2005, which is incorporated by reference herein in its entirety.

### TECHNICAL FIELD

The disclosed subject matter relates generally to computer graphics, and more particularly, to the simultaneous application of different event based animations techniques on user interfaces for creating dynamic visual transitioning effects without disrupting the animations.

### BACKGROUND

Software applications may often leverage graphical or visual user interfaces to convey information and/or provide users with feedback during execution.

### SUMMARY

The following section of this patent application document presents a simplified summary of the disclosed subject matter in a straightforward manner for readability purposes only. In particular, this section attempts expressing at least some of the general principles and concepts relating to the disclosed subject matter at a relatively high-level simply to impart a basic understanding upon the reader. Further, this summary does not provide an exhaustive or limiting overview nor is it intended to identify key and/or critical elements of the disclosed subject matter. Accordingly, this section does not delineate the scope of the ensuing claimed subject matter and therefore the scope should not be limited in any way by this summary.

As such, an animation model may be implemented for managing a number of animation sequences that may be associated with one or more user interfaces during software application execution. Animation transitioning effects may be used to indicate that some user interaction is taking place. For instance, a first user interface (e.g., button) displayed on a computer's monitor may be animated by growing, shrinking or rotating the user interface responsive to user interactions, such as positioning a second user interface (e.g., cursor) over the first user interface, for example. Further, a number of different animation effects may sometimes be called upon by an executing software application responsive to application events to be applied simultaneously and/or at varying times on different or even the same user interfaces displayed on a computer's monitor at substantially the same time, for example.

A portion of the disclosed animation model may involve logically organizing one or more of elements of animation sequences, which may be applied on user interfaces, into separate groups that may be managed by a number of components in the disclosed animation model. For instance, at least one first component may manage a first group of visual elements that may be actively rendered to display one or more user interfaces used by an executing software application. At least one second component may handle managing, monitoring, obtaining, generating and/or implementing one or more animation sequences that may be associated with the rendering visual elements. At least one third component may manage a second group of discarded or orphaned visual elements that may be disassociated from the first group of rendering visual elements responsive to one or more software application execution events calling for the disposal of those orphaned visual elements.

Rather than allowing the orphaned visual elements to be disposed of along with any associated active animation sequences that may still be animating or may not yet begun animating, however, at least one fourth component may separately maintain orphaned visual elements that may be associated with one or more active animation sequences to allow the animation sequences to complete. Less dramatic or abrupt animation transition effects may result by avoiding the premature halting of any active animation sequences associated with the orphaned visual elements, for example.

### BRIEF DESCRIPTION OF THE DRAWINGS

The ensuing detailed description section will be more readily appreciated and understood when read in conjunction with the accompanying drawings, wherein:

FIG. 1 is a block diagram of an example of a computing system environment that may be used to implement a disclosed animation model;

FIG. 2 is a block diagram of an example of an implementation of a disclosed animation model in the exemplary computing system environment shown in FIG. 1;

FIG. 3 is a flow chart of an example of a method that may be implemented for generating event based animation sequences that may be associated with user interfaces;

FIG. 4 is a graphical representation of one or more particular types of animation sequences that may be implemented in the disclosed animation model;

FIGS. 5-9 are diagrams of one or more portions of an exemplary animation object model library that may be implemented in a disclosed animation model for defining event based animation sequences that may be associated with user interfaces;

FIG. 10 is a diagram illustrating a transitioning effect resulting from a first active animation sequence that may be interrupted by a second active animation sequence during software execution;

FIG. 11 is a flow chart of an example of a method that may be implemented for enabling active animation sequences that may be associated with discarded rendering objects to continue rendering;

FIG. 12 is a functional block diagram depicting an exemplary layout process that may be implemented in the disclosed animation model to select graphical rendering elements that may be generated for rendering based on associated user interface elements utilized during software application execution;

FIGS. 13-14 are diagrams of exemplary user interface element arrangements showing associated graphical rendering elements to be rendered along with any associated animation sequences;

FIG. 15 is a diagram for an example of a collection of one or more orphaned graphical rendering elements that may be associated with at least one active animation sequence and may be disposed of during software application execution;

FIGS. 16-17 are diagrams of one or more current and/or orphaned graphical rendering elements with at least one associated active animation sequence; and

FIG. 18 is a graphical representation of a transitioning effect resulting from a first active animation sequence that may be implemented simultaneously with a second active animation sequence for the same graphical rendering element.

The same reference numerals and/or other reference designations employed throughout the accompanying drawings are used to identify identical components except as may be provided otherwise.

### DETAILED DESCRIPTION

The accompanying drawings and this detailed description provide exemplary implementations relating to the disclosed subject matter for ease of description and exemplary purposes only, and therefore do not represent the only forms for constructing and/or utilizing one or more components of the disclosed subject matter. Further, while the ensuing description sets forth one or more exemplary operations that may be implemented as one or more sequence(s) of steps expressed in one or more flowcharts, the same or equivalent operations and/or sequences of operations may be implemented in other ways.

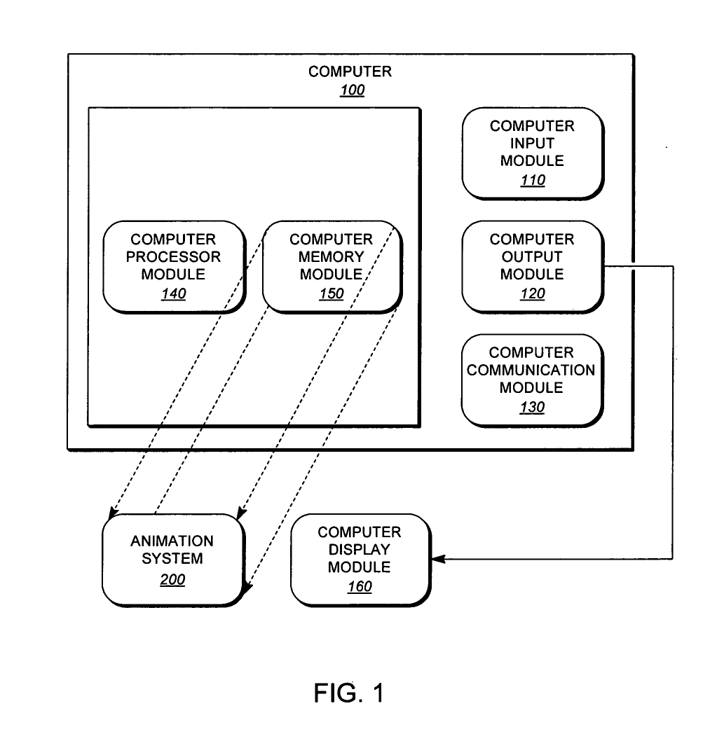

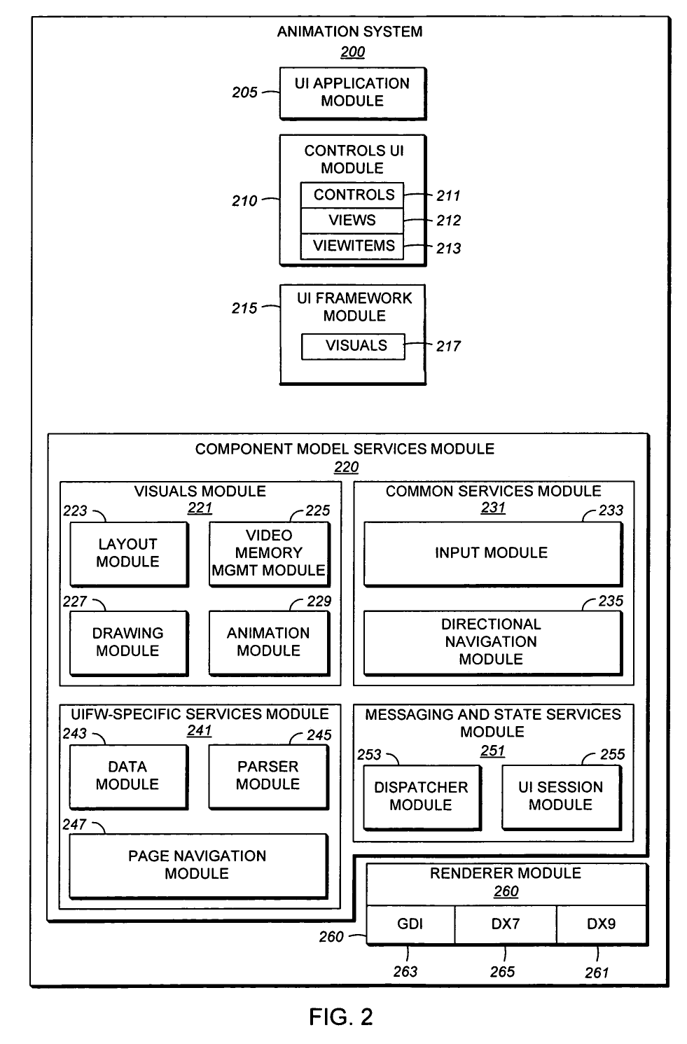

FIGS. 1 and 2 illustrate an example of an animation system 200 that may be implemented on a computer 100 to maintain active animation sequences that may correspond to one or more rendering elements (hereinafter referred to as “Visuals” and variations thereof) discarded by a software application executing on the computer 100, for instance. Basically, one or more user interface elements (hereinafter referred to as “ViewItems” and variations thereof) representing user interfaces utilized by the executing software application may be maintained by the animation system 200 in a ViewItem data structure. The ViewItems may represent one or more portions of user interfaces that may be rendered by the system 200. Further, the system 200 may maintain a second data structure that may include one or more of the Visuals. The Visuals may represent actual rendering elements that may be implemented by the system 200 to display the user interfaces represented by the ViewItems on computer display module 160, for example.

During software application execution, the animation system 200 may handle the manner in which one or more of the Visuals may be displayed on computer display module 160. Sometimes, the animation system 200 may determine that one or more rendering Visuals may not be rendered after all because one or more layout constraints may not be met responsive to one or more application execution and/or user interaction events, for example. When Visuals may no longer be needed, some systems may simply determine that the Visuals may be disposed of. However, one or more of the Visuals may be associated with active animations that may not be able to complete if the Visuals are abruptly disposed of.

The animation system 200 may instead separately manage discarded or orphaned Visuals (“orphaned Visuals”) that may be disposed of in a third data structure. Any active animations associated with any of these orphaned Visuals may then continue animating until the animation system 200 may determine that they may have completed, for example. As such, additional context information and detail will now be provided in connection with a more detailed description of the components that may be used to implement the animation system 200.

Generally, show/hide animation effects, blending animation effects, cross-fade animation effects and any other type of animation effect are effective implements that may be used in the animation system 200 for conveying information during software application execution. Coordinating multiple animations that may be applied simultaneously on the same or different user interfaces is challenging. For instance, an executing software application event may cause rendering Visuals to be discarded before their associated active animations may complete or even begin.

An application event that may call for a first Visual element displayed in computer display module 160 to be replaced with a second Visual element may result in preventing any active animation sequences associated with the first Visual element from beginning as intended. Moreover, if the active animation sequences associated with the first Visual elements have begun animating when replaced by the second Visual element, then this interruption may generate a visually noticeable or relatively dramatic transition in the computer display module 160 that may appear to users as a “glitch,” for example. This undesirable effect may come about as a result of the first and second Visual elements both addressing the same rendering sources.

The disclosed animation system 200 attempts to address at least some of the issues noted above by substantially preventing Visual elements with any associated active animations from being interrupted by application execution events. A substantial blending of two or more active animation sequences may be created in the animation system 200 without interrupting or modifying any rendering and/or orphaned Visual elements.

Referring now specifically to FIG. 1, an example of a suitable operating environment in which the disclosed animation system 200 may be implemented is presented as computer 100. The exemplary operating environment illustrated in FIG. 1 is not intended to suggest any limitation as to the scope of use or functionality of the animation system 200. Other types of computing systems, environments, and/or configurations that may be suitable for use with the animation system 200 may include, but are not limited to, hand-held, notebook or laptop devices, multiprocessor systems, microprocessor-based systems, programmable consumer electronics, network PCs, minicomputers, mainframe computers, distributed computing environments that may include any of the above systems or devices, and other systems.

As such, computer 100 in its most basic configuration may comprise computer input module 110, computer output module 120, computer communication module 130, computer processor module 140 and computer memory module 150, which may be coupled together by one or more bus systems or other communication links, although computer 100 may comprise other modules in other arrangements.

Computer input module 110 may comprise one or more user input devices, such as a keyboard and/or mouse, and any supporting hardware. Computer input module 110 may enable a user who is operating computer 100 to generate and transmit signals or commands to computer processor module 150.

Computer output module 120 may comprise supporting hardware and/or software for controlling one or more information presentation devices coupled to computer 100, such as computer display module 160.

Computer communication module 130 may comprise one or more communication interface devices, such as a serial port interface (e.g., RS-232), a parallel port interface, a wire-based (e.g., Ethernet) or wireless network adapter, and any supporting hardware, although other types of communication interface devices may be used. Computer communication module 130 may enable computer 100 to transmit data to and receive data from other computing systems or peripherals (e.g., external memory storage device, printer or other computing system) via one or more communication media, such as direct cable connections and/or one or more types of wireless or wire-based networks.

Computer processor module 140 may comprise one or more mechanisms that may access, interpret and execute instructions and other data stored in computer memory module 140 for controlling, monitoring and managing (hereinafter referred to as “operating” and variations thereof) computer input module 110, computer output module 120, computer communication module 130 and computer memory module 150 as described herein, although some or all of the instructions and other data may be stored in and/or executed by the modules themselves.

Computer processor module 140 may also access, interpret and/or execute instructions and other data in connection with performing one or more functions to implement at least a portion of the animation system 200, although processor module 140 may perform other functions, one or more other processing devices or systems may perform some or all of these functions, and processor module 140 may comprise circuitry configured to perform the functions described herein.

Computer memory module 150 may comprise one or more types of fixed and/or portable memory accessible by computer processor module 150, such as ROM, RAM, SRAM, DRAM, DDRAM, hard and floppy-disks, optical disks (e.g., CDs, DVDs), magnetic tape, ferroelectric and ferromagnetic memory, electrically erasable programmable read only memory, flash memory, charge coupled devices, smart cards, or any other type of computer-readable media, which may be read from and/or written to by one or more magnetic, optical, or other appropriate reading and/or writing systems coupled to computer processor module 140 and/or one or more other processing devices or systems.

Computer memory module 150 may store at least a portion of the instructions and data that may be accessed, interpreted and/or executed by computer processor module 140 for operating computer input module 110, computer output module 120, and computer communication module 130, although some or all of the instructions and data may be stored elsewhere, such as in the modules themselves and/or the computer processor module 140.

Computer memory module 150 may also store one or more instructions that may be accessed, interpreted and/or executed by computer processor module 140 to implement at least a portion of the animation system 200, although one or more other devices and/or systems may access, interpret and/or execute the stored instructions. The one or more instructions stored in computer memory module 150 may be written in one or more conventional or later developed programming languages or expressed using other methodologies. Furthermore, the one or more instructions that may be executed to implement at least a portion of the animation system 200 are illustrated in FIG. 2 as one or more separate modules representing particular functionalities.

Computer display module 160 may comprise one or more user output devices, such as a computer monitor (e.g., CRT, LCD or plasma display), which may be used for presenting information to one or more users. although other types of output devices may be used, such as printers. Further, computer display module 160 may display information output from computer output module 120, although the information may be output from other sources.

Referring to FIG. 2, an exemplary implementation of an animation system 200 will now be described. The exemplary modules shown in FIG. 2 are provided for ease of description and illustration, and should not be interpreted to require the use of any specific infrastructures nor require any specific software packages, such as DirectX®, for example. As such, the system 200 illustrated in FIG. 2 and the following description is provided merely as examples of how such an animation system 200 may be designed and implemented.

Generally, an animation system 200 may include UI application module 205, controls UI module 210, UI framework module 215, component model services module 220, and renderer module 260. Further, one or more of the modules 205, 210, 215, 220 and 260 may further comprise one or more other modules, examples of which are described herein below with continued reference to FIG. 2.

UI application 205 may comprise a top level control application that may manage operation of a media user interface by calling one or more routines on control UI 210 and/or UI framework 215 based on a user's interaction with a media user interface that may be presented to users via computer output module 120 using computer display module 160.

Controls UI module 210 may manage the operation of one or more user interfaces displayed on the computer display module 160, which may be defined by and represented in FIG. 2 by Controls 211, Views 212 and ViewItems 213. Generally, Controls 211, Views 212 and View Items 213 may be managed in one or more objects logically organized into one or more data structures in the animation system 200, such as a tree-like data structure or any other type of data structure, for example.

Controls 211 may provide one or more media user interfaces, such as buttons, radio lists, spinner controls and other types of interfaces, which may be provided for handling input, focusing, and/or navigating, for example.

Views 212 may represent the owner of a display for a Control 211, for example. Further, Views 212 may request that a Visual 217 for the Control 211 be drawn and/or displayed on the computer display module 160. Thus, Views 212 may cause a visual representation of Control 211 to be displayed as part of a media user interface displayed on computer display module 160.

ViewItems 213 may define and represent content in FIG. 2 (e.g., Visuals 217) to be rendered or drawn on computer display module 160 by renderer module 260, for example. ViewItems 213 may also comprise logic for determining how the content may be used, such as whether the content may be used as a Control 211 or as a portion of an animation sequence associated with the ViewItems 213.

UI Framework module 215 may provide at least one abstraction layer between UI application 205 and component model 220. In particular, UI Framework module 215 may implement a managed user interface description environment that may provide a high level programming interface for configuring the renderer module 260.

Further, UI Framework module 215 may define and enable objects to be used for describing images, animations and/or transforms, for example, using a high-level declarative markup language (e.g., XML) and/or source code written in any number of conventional and/or later developed languages (e.g., C, C++, C#). The UI Framework module 215 may enable the UI application 205 to provide one or more routines and definitions that may make up, define, and/or control the operation of a media user interface displayed on computer display module 160, for example.

Component model service module 220 may generally comprise Visuals module 221, Common Services module 231, UI Framework-specific (“UIFW”) services module 241 and messaging and state services module 251. Modules 221, 231, 241 and 251 further comprise one or more other modules, examples of which will now be described below.

Visuals module 221 may comprise layout module 223, video memory management module 225, drawings module 227, and animation module 229.

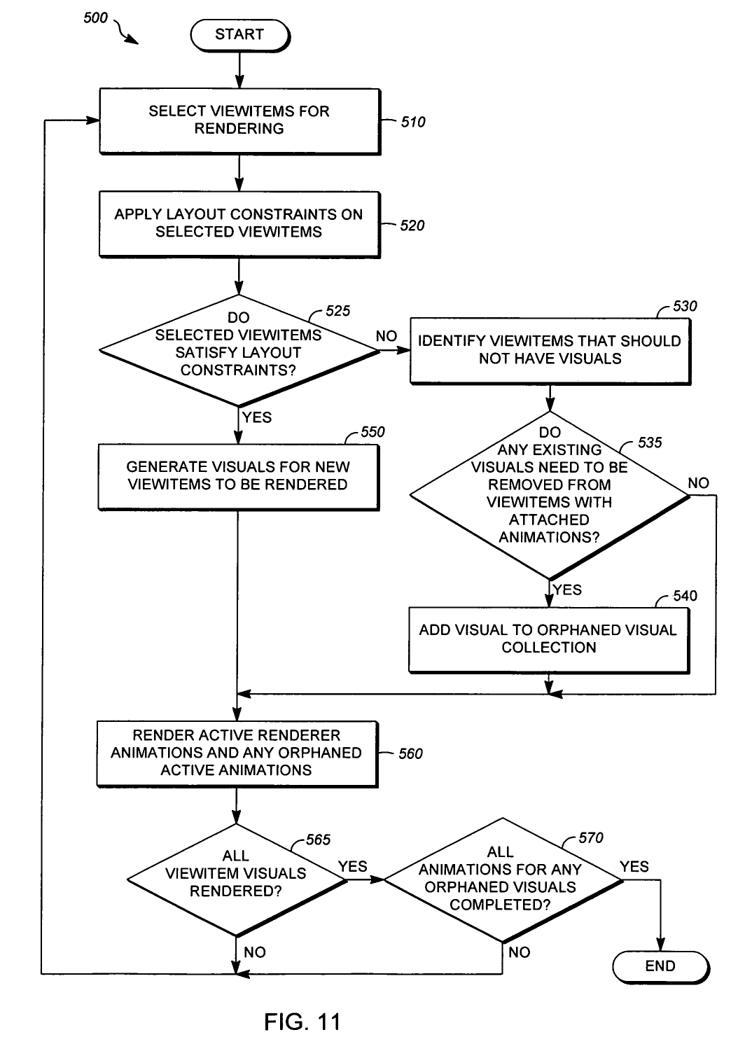

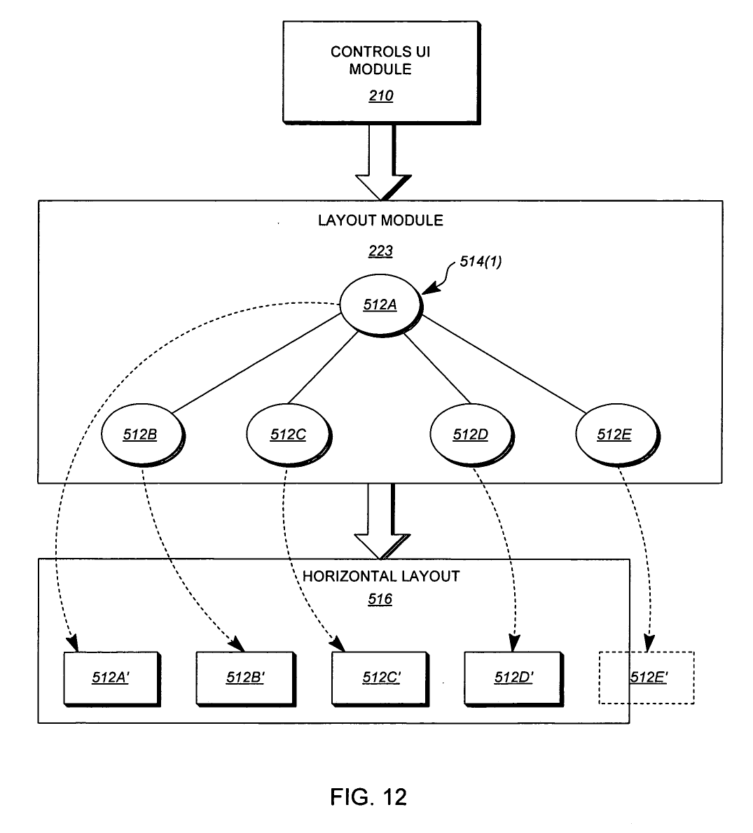

Layout module 223 may determine whether one or more ViewItems 213 to be rendered may satisfy one or more layout constraints that may be defined within UI framework module 215, for example, prior to generating one or more Visuals 217 to be rendered by renderer module 260 as described further herein below in connection with FIGS. 11 and 12, for example.

Video memory mgmt 225 may manage data and instructions that may be sent to a portion of computer output module 120 configured to communicate with computer display module 160, including management of surfaces, vertex buffers and pixel shaders, for example.

Drawing services module 227 may manage any non-animated visual component to be drawn on a user interface, including text, for example.

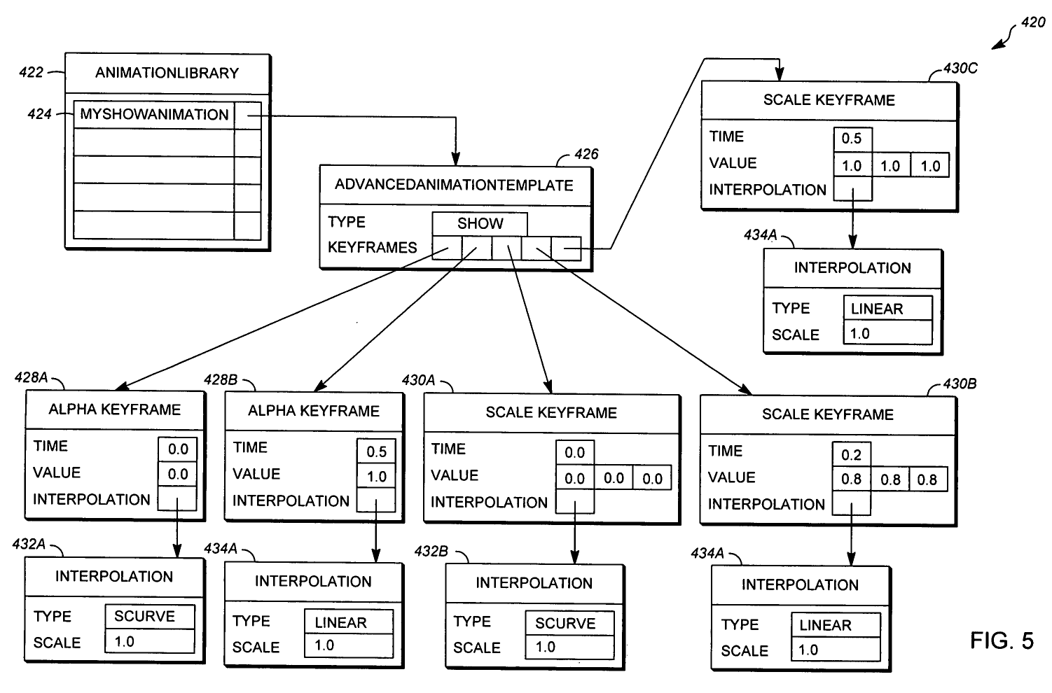

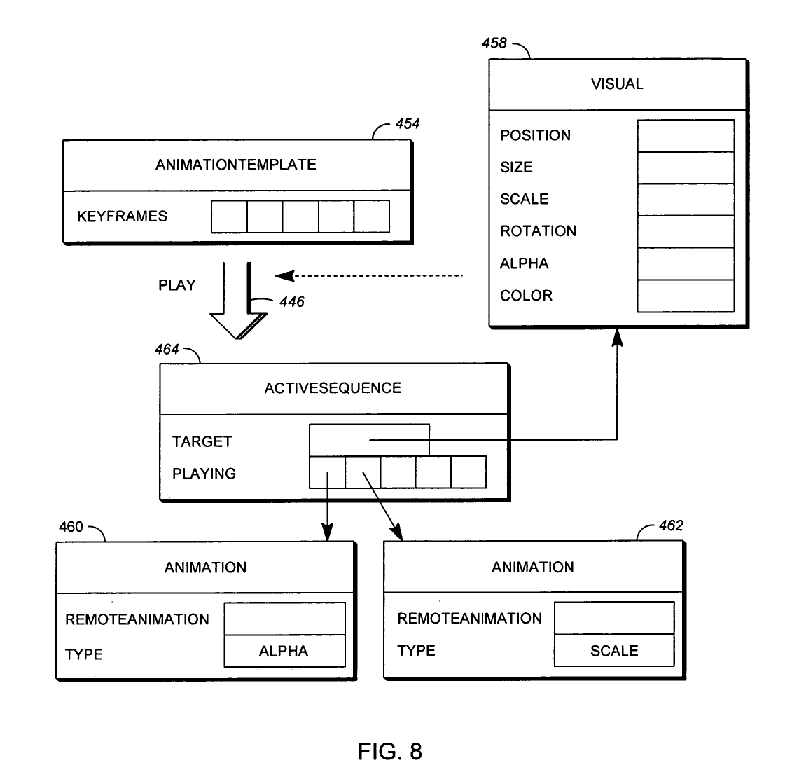

Animation module 229 may comprise a portion of the functionality used by component module 220 and renderer module 260. The portion of the functionality from component model 220 may represent build functionalities for building one or more animation templates that may describe an object, a destination, a timer-period, an animation method, stop points, and any other animation related data, examples of which are described further herein below in connection with FIGS. 5 and 8.

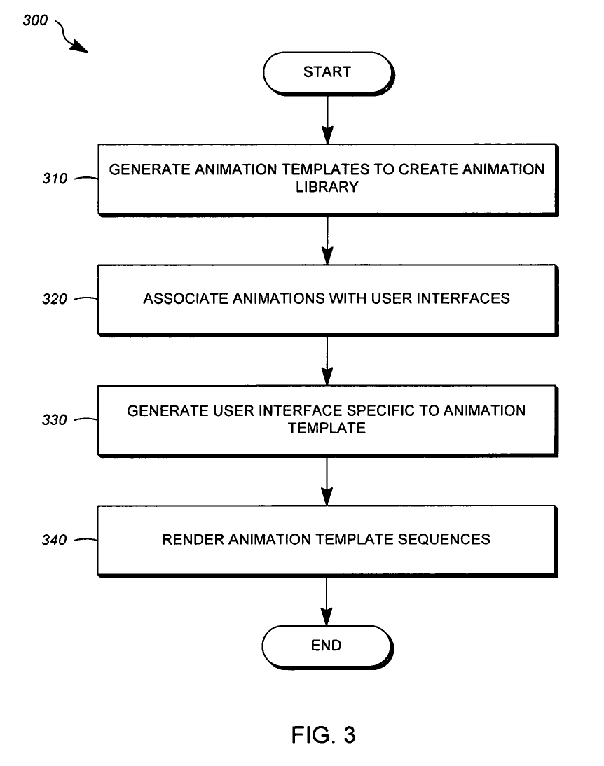

Generally, the animation templates may include one or more Keyframes that may describe a value for some point in time and the manner in which to interpolate between that keyframe and a next defined keyframe, for example, as described further herein below in connection with FIG. 5. The renderer module 260 may play these animation templates, at which time animation module 229 may build an active animation sequence (e.g., ActiveSequence 464 shown in FIG. 8) in the manner described below in connection with method 300 illustrated in FIG. 3, for example. Once an active animation sequence is built, the renderer module 260 may execute one or more frames defined for the animation to cause one or more portions of the associated Visuals 217 displayed on computer display module 160 to appear to move or be animated.

Common services module 231 may comprise input module 233 and directional navigation module 235. Input module 233 may manage a state machine that may determine how to process user input (e.g., mouse moves, etc.) based on a specific view of a user interface. It should be noted that the user input processed by input module 233 may already be at least partially processed at some level by computer input module 110 substantially prior to and/or substantially concurrently with being processed by input module 233.

Directional navigation module 235 may identify a same-page move destination based on a center point of a current screen selection, other targets on-screen, and/or direction indicated by a user, for example.

UIFW-specific services module 241 may comprise data module 243, parsing module 245, and page navigation module 247. Data module 243 may provide data sources for Visuals 217, manage binding according to predetermined binding rules, and/or allow variables to reference data to be defined as needed. For example, data module 243 may be used to associate a photo item's display name property with a thumbnail button's Text View Item Content property. Accordingly, when a property on one or more of the objects is set or changes, the related property on the other object(s) may be set or change as well, although their relationships may not always be bound one-to-one relationships. When a value on a bound object changes, however, the binding may be marked as “dirty” and, at substantially a later time, the dispatcher module 253 may call a process to reevaluate such dirty bindings that in turn may cause data module 243 to propagate new values to each dirty binding's destination, for example.

Parser module 245 may parse one or more high-level descriptions of a media user interface that may be expressed using declarative statements (e.g., XML) via UI framework module 215, although the descriptions may be expressed in other ways. For instance, XML may be used to create visual aspects of a media user interface that may be displayed on computer display module 160, in addition to hand-authoring visual aspects of the media user interface in one or more programmatic languages, such as C, C++, and/or C#. Page navigation module 247 may identify inter page navigations based on a selected content item, for example.

Messaging and state services module 251 may comprise dispatcher module 253 and UI Session module 255. Dispatcher module 253 may manage the processing of time requests for components in a shell environment that may be implemented by computer 100. It should be noted that one or more of the components managed by UI framework module 215 described above earlier may run as part of the shell process. Further, dispatcher module 253 may be extensible to allow the creation and expression of new priority rules as needed, such as to allow a new rule that runs a particular task after substantially all painting tasks but substantially before any timer tasks, for example.

UI Session module 255 may comprise a state container that manages data related to a set of objects that may be managed by the animation system 200, for example. Other modules in animation system 200, such as renderer module 260, layout module 223 and drawing module 227, may manage their data as sub-objects in UI session module 255. Moreover, UI Session module 255 may establish a port to communicate with each module so that each module can refer to its portion of the data for handling its own tasks.

Renderer module 260 may comprise logic for drawing and sending a resulting media user interface to a portion of computer memory module 150 in computer 100 that may be configured to store video memory. Further, renderer module 260 may operate on its own thread and may receive information from UI framework module 215, such as one or more Visuals 217, which may describe what to draw. Renderer module 260 may also include and/or communicate with one or more sub-rendering modules based on a graphical development application that may have be used for the media user interface, such as DirectX® 9 261, GDI 263, DirectX® 7 265, or any other type of graphical development applications including later developed versions thereof.

As mentioned earlier, Visuals 217 may represent a basic drawing unit for the renderer module 260, which again may be logically organized as a collection of one or more Visuals 217 in one or more data structures that may describe painting or rendering order, containership relationships and other information. Visuals 217 may also describe and represent the content to be drawn, such as an image, text, color, and any other type of content that may be drawn or expressed. Further, the Visuals 217 managed in UI framework module 215 may correspond to Visual objects maintained in renderer module 260. This may facilitate communication between the UI framework module 215 and the renderer module 260 when the UI framework module 215 provides one or more instructions describing what the renderer module 260 may draw or render, for example.

A method 300 that may be implemented to generate one or more event based animations for one or more user interfaces will now be described with reference to FIGS. 3-9 in the context of being carried out by the animation system 200 implemented on computer 100 described above in connection with FIGS. 1-2. Referring to FIGS. 3-5, and beginning the method 300 at step 310, by way of example only, an operator of the computer 100 using the computer's input module 110, in conjunction with operation of at least one of either the computer's output module 120, communication module 130, processor module 140, memory module 150, and/or display module 160, may begin defining one or more properties of an animation that may be associated with one or more user interfaces.

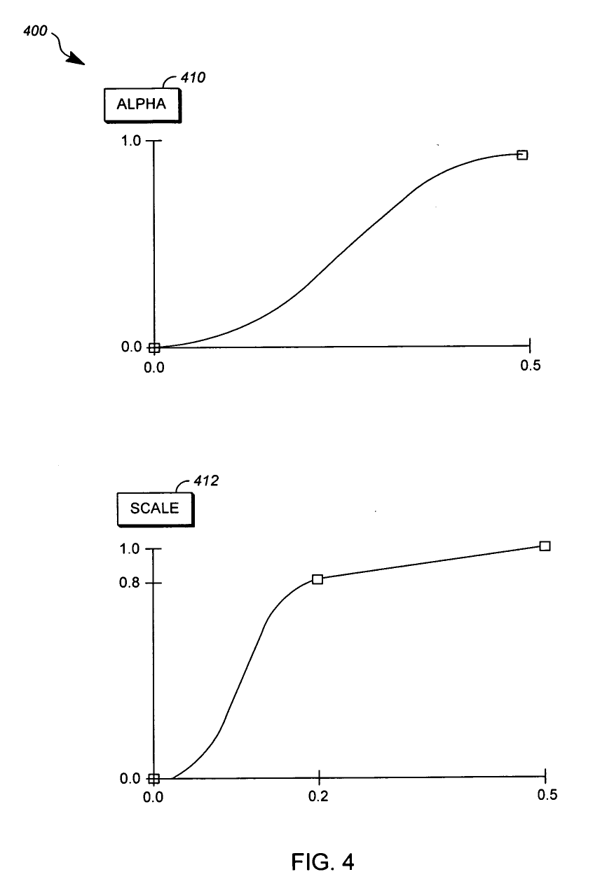

Examples of such animation sequences are graphically depicted in FIG. 4 as animation sequence 400. The operator may use an editor application that may be operating on computer 100 to express and/or define one or more animation templates using one or more declarative markup languages, such as XML, although the animation templates may be expressed in other ways, such as using programmatic languages. An example of an animation sequence object model library 420 is shown in FIG. 5, described further herein below. Generally, however, animation templates may define and/or describe one or more properties of the animations sequences (e.g., animation sequence 400), for example.

For instance, the animation sequence 400 shown in FIG. 4 may be described with one or more keyframes. Basically, a keyframe may represent a property value at a particular point in time in an animation sequence (e.g., animation sequence 400). In the animation sequence 400, for example, one or more properties of the animation sequence 400 are shown as being an alpha 410 property corresponding to an amount of opacity and a scale 412 property corresponding to a scaling value for the animation sequence 400, although other properties may be represented, such as color, size, rotation, position, and/or any other animation property.

An exemplary portion of declarative markup language that may be used to describe a logical collection of one or more keyframes describing and/or defining an animation template named “MyShowAnimation” that may correspond to the exemplary animation sequence 400 shown in FIG. 4 is provided below:

```
  <AdvancedAnimationTemplate Name=“MyShowAnimation”
  Type=“Show”>
  <Keyframes>
    <AlphaKeyframe Time=“0.0” Value=“0.0”
InterpolationType=“SCurve”/>
    <ScaleKeyframe Time=“0.0” Value=“0.0, 0.0, 0.0”
InterpolationType=“SCurve”/>
    <ScaleKeyframe Time=“0.2” Value=“0.8, 0.8, 0.8”/>
    <AlphaKeyframe Time=“0.5” Value=“1.0”/>
    <ScaleKeyframe Time=“0.5” Value=“1.0, 1.0, 1.0”/>
  </Keyframes>
</AdvancedAnimationTemplate>
```

As shown above, one or more keyframe tags may be described using a particular time value, a particular property value and/or a particular type value, for example, although keyframes may be described in other ways. Accordingly, one or more of the keyframe tags in the example shown above may provide a time value corresponding to either the alpha property 410 or the scale property 412 of the animation sequence 400 shown in FIG. 4, in addition to an interpolation type value, for example.

The interpolation type value may identify one of perhaps several different interpolation methods that may be implemented when transitioning from one keyframe to another keyframe, including linear, sine curve, exponential, logarithmic and/or any other type of interpolation or conversion method, for example. Furthermore, the “MyShowAnimation” animation template example provided above may also be described using a collection of one or more objects shown in FIG. 5, for example.

Referring now to FIG. 5, an animation object library 420 that may represent one or more animation sequences that may be associated with one or more user interfaces is provided for exemplary purposes. An AnimationLibrary object 422 may comprise one or more entries identifying one or more animation templates, such as MyShowAnimation entry 424 corresponding to the “MyShowAnimation” markup language example provided above.

AdvancedAnimationTemplate object 426 may comprise one or more entries for defining the one or more animation templates identified in the entries within the AnimationLibrary object 422, such as the MyShowAnimation entry 424. The object 426 may also comprise one or more other entries for defining the one or more keyframes describing the animation template named “MyShowAnimation,” which are shown in FIG. 5 as Alpha keyframe objects 428A and 428B and Scale keyframe objects 430A, 430B, and 430C, for example.

AdvancedAnimationTemplate object 426 may also provide additional information describing the context in which an associated animation sequence may be played, such as identifying particular actions to be taken in response to particular events occurring. For instance, object 426 in this example may identify a “Show” event that may initiate a show animation sequence when an associated user interface associated with the animation template may be initially, for example. For instance, one or more properties of one or more associated user interfaces (e.g., ViewItems 213) may be manipulated to cause the user interfaces to appear to be gradually becoming visible in computer display module 160, for example. Other events that may be identified in an animation template object (e.g., AdvancedAnimationTemplate object 426) may include, but are not limited to, Hide, Move, Size, GainFocus, LoseFocus and Idle events.

A Hide event may initiate a hide animation sequence that may manipulate one or more properties of the associated user interfaces to cause the interfaces to appear to be gradually disappearing from computer display module 160 when the state of the user interface changes from active or shown to hidden or inactive, for example. A Move event may initiate a move animation sequence that may manipulate one or more properties of the associated user interfaces to change interface's position in computer display module 160 when the layout module 223 relocates the user interface, for example. A Size event may initiate a size animation sequence that may manipulate one or more properties of the associated user interfaces to change the interface's displayed size in computer display module 160 when the layout module 223 resizes user interface, for example.

A GainFocus event may initiate a focus gaining animation sequence that may manipulate one or more properties of a Control 211 associated with a user interface when the Control 211 associated with a ViewItem's View 212 gains keyboard focus, for example. A LoseFocus event may initiate a focus losing animation sequence that may manipulate one or more properties of a Control 211 associated with a user interface when the Control 211 associated with a ViewItem's View 212 loses keyboard focus, for example. An Idle event may initiate an idle animation sequence on the associated user interfaces displayed in computer display module 160 when none of the other animation sequences are being implemented, for example.

As mentioned above, Alpha keyframe objects 428A and 428B and Scale keyframe objects 430A, 430B, and 430C may represent the keyframes defined in the “MyShowAnimation” animation template, for example. Further, SCurve Interpolation objects 432A and 432B, and Linear Interpolation objects 434A and 434B, may represent the interpolation values that may be defined for the keyframe objects 428A and 428B and 430A, 430B, and 430C.

At step 320, the animation sequence 400 depicted graphically in FIG. 4 and the animation object library 420 shown in FIG. 5 may be associated with one or more user interfaces, for example. Declarative markup language may also be used to define an association between the animation object library 420 and the user interfaces. An exemplary portion of declarative markup language that may be used to describe such an association is provided below:

```
<View Name=“MyView”>
  <Content>
    <SolidFillViewItem Name=“ColorFill”>
      <Color>255, 255, 255</Color>
      <Animation>$Animations(MyShowAnimation)</Animation>
    </SolidFillViewItem>
  </Content>
</View>
```

The exemplary portion of declarative markup language provided above may include a SolidFillViewItem tag, which may describe a solid colored ViewItem named “ColorFill” that may be associated with the animation sequence 400 represented by the animation object library 420 shown in FIG. 5. It should be noted that the “MyView” View may represent one of a number of user interfaces that can be defined using declarative markup language, for example, although Views could be defined in other ways. In any event, the parser module 245 may search for the animation template (e.g., “MyShowAnimation”) identified by an Animation tag embedded in the markup language example provided above by referencing the one or more entries in AnimationLibrary object 422 to identify any matches, such as the MyShowAnimation entry 424, for example.

At step 330, a user interface-specific animation template may be generated that may be based on an animation template identified in a ViewItem. Basically, one or more values identifying a particular animation template (i.e., “MyShowAnimation”) may be defined in the Animation tag embedded in the markup language example provided above for the “MyView” View via one or more parameters, for example.

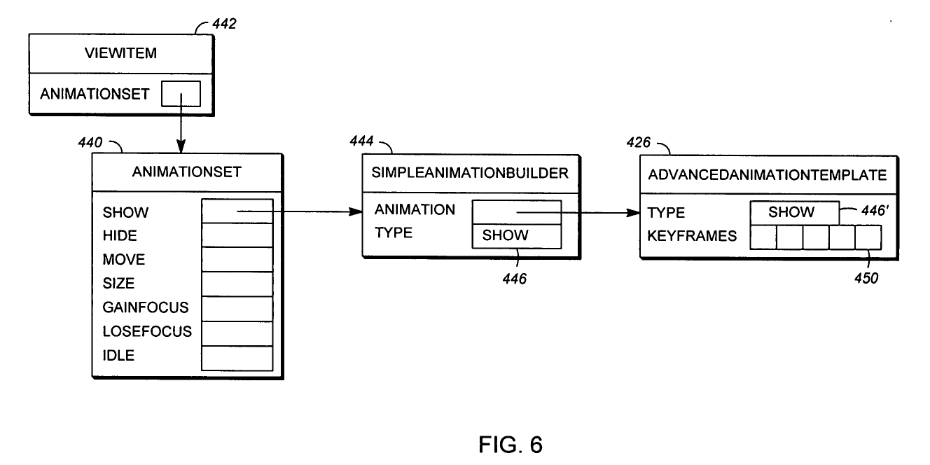

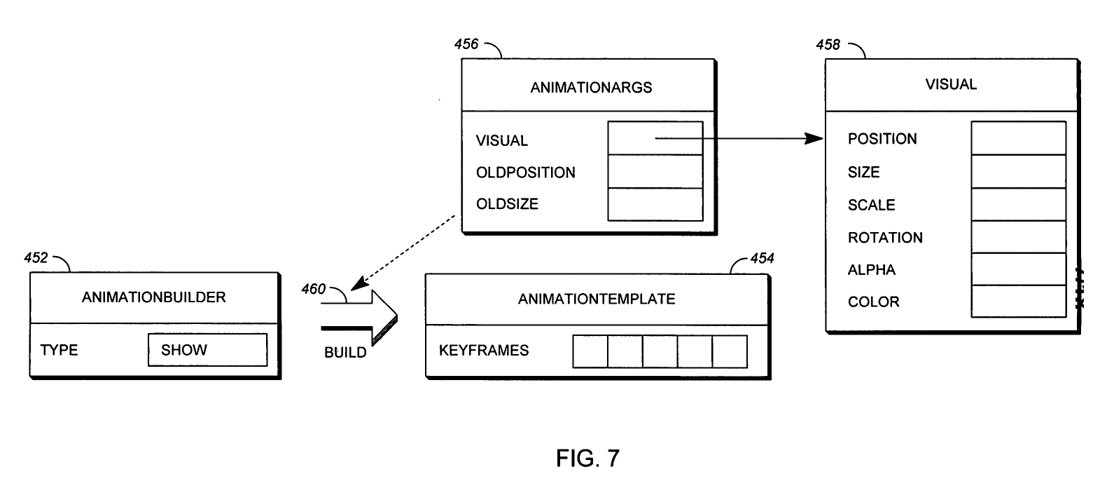

Referring to FIG. 6, animation module 229 in the animation system 200 may instantiate an AnimationSet object 440 that may be associated with a ViewItem object 442. In turn, the associated ViewItem object 442 instantiate a SimpleAnimationBuilder object 444 that may be based on the animation template's type 446 (e.g., show, hide). The SimpleAnimationBuilder object 444 may be derived from an animation builder class, which may be instantiated to generate an AnimationBuilder object 452 shown in FIG. 7, for example.

Generally, the SimpleAnimationBuilder object 444 in this example may represent a particular type of AnimationBuilder object 452 that may return a particular type of animation sequence (e.g., Show, Hide, etc.) when one or more build methods on the object 452 may be called. An example of a particular type of animation sequence that may be returned by the object 452 is depicted as AdvancedAnimationTemplate object 426 in FIGS. 5 and 6. In contrast, the AnimationBuilder object 452 may return a number of different animation sequences, such as AnimationTemplate object 454 shown in FIG. 7, for example.

In any event, SimpleAnimationBuilder object 444 may generate an AdvancedAnimationTemplate object 426, initially introduced in this description in connection with FIG. 5, which may be specific to the ViewItem object 442. Thus, the AdvancedAnimationTemplate object 426 may be defined with a type 445 that may be derived from the animation template's type 446 identified in the SimpleAnimationBuilder object 444. Moreover, the AdvancedAnimationTemplate object 426 may include keyframes 450 derived from the AdvancedAnimationTemplate object 426 shown in FIG. 5, for example.

Referring to FIGS. 7 and 8, an AnimationArgs object 456 may be passed as a parameter into a build call 460 that may be made on an AnimationBuilder object 452 to obtain an AnimationTemplate object 454, for example. The following programmatic language statement is provided for exemplary purposes only to show a programmatic example of the build call 460 in this example:

AnimationTemplate AnimationBuilder.Build(AnimationArgs args)

Responsive to the call 460, AnimationBuilder object 452 may generate an AnimationTemplate object 454. The particular type of AnimationTemplate object 454 that may be returned may depend on the particular values passed in the build call 460 via the AnimationArgs object 456, although the object 456 may generate the AnimationTemplate object 454 in a particular manner regardless of the provided values, AnimationBuilder object 452 may use a default animation template to generate the AnimationTemplate object 454, AnimationBuilder object 452 may select one of many animation templates to generate the AnimationTemplate object 454, AnimationBuilder object 452 may programmatically generate an animation template for generating the AnimationTemplate object 454, or any other way.

At step 340, an AnimationTemplate object 454 obtained at step 330 may be instantiated using a play call 446 to obtain an ActiveSequence object 464, for example, as shown in FIG. 8. The following programmatic language statement is provided for exemplary purposes to show a programmatic example of a play call 446 that may be made to instantiate the AnimationTemplate object 454 for obtaining an ActiveSequence object 464 in this example:

ActiveSequence AnimationTemplate.Play(Visual visualTarget)

The ActiveSequence object 464 may represent a running instance of the AnimationTemplate object 454. The renderer module 260 may render the animation sequence defined by the ActiveSequence object 464, for example. Further, the ActiveSequence object 464 may represent a logical collection of one or more Animation objects 460 and 462 (e.g., Alpha, Scale), which may provide handles 461 and 463, respectively, to particular animation sequences defined in the ActiveSequence object 464.

Specifically, renderer module 260 may execute one or more animation sequences defined by the first render animation object 460 and/or the second render animation object 462 according to one or more floating point values that may be defined in the objects 460, 462, for example. For example, if animation objects 460, 462 represent a position animation sequence, then there may be three sequences to define a particular position, such as one sequence for each one of x, y and/or z. Each sequence may be punctuated with keyframes.

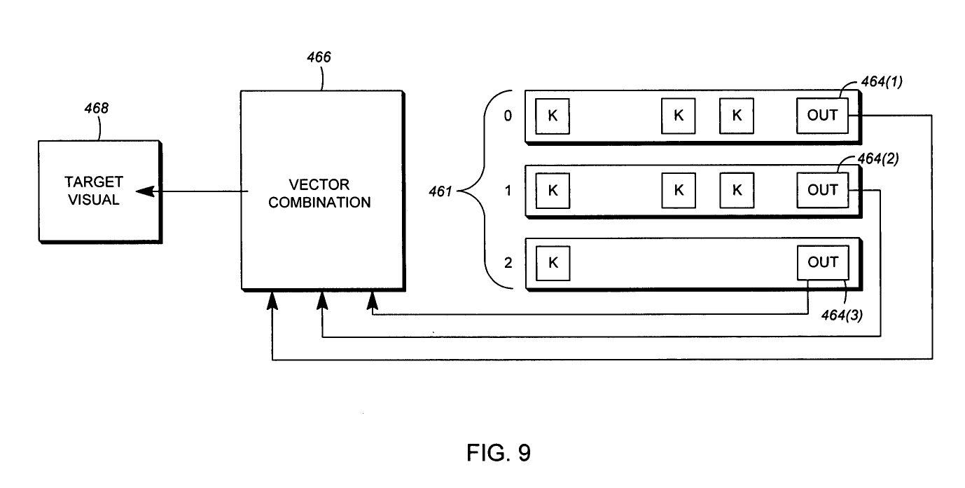

Further, the renderer module 260 may evaluate one or more of the active animations in the render thread before rendering each frame in an animation. Each sequence may be assigned a tick or time value and the sequence's value may be evaluated based on that time. The resulting values may be passed into a vector combination object 466 shown in FIG. 9, which may process the values accordingly based on the particular animation properties that the values may be associated with.

For instance, if the sequence values represent a position property for an active animation sequence, the vector combination object 466 may convert and/or otherwise transform those values into a position vector. Further, the renderer module 260 may apply the converted vector onto a Visual position property 457 of a particular Visual object 458, for example. When the renderer module 260 has rendered all of the frames in all of the active animation sequences in the render thread, the animation rendering may be complete and the method 300 may end.

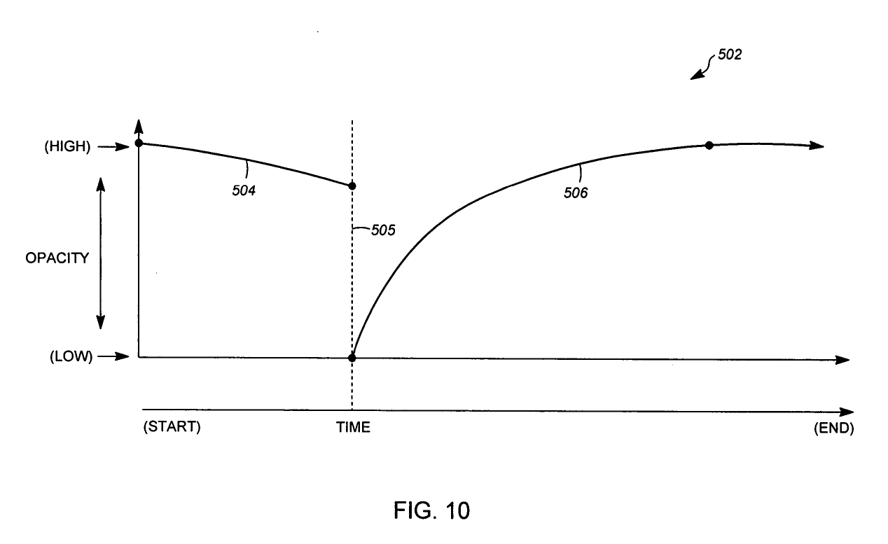

An exemplary method 500 for maintaining live rendering objects with active animations that have been discarded by executing software applications will now be described with reference to FIGS. 10-17 in the context of being carried out by the animation system 200 described above in connection with FIGS. 1-8. Events taking place during software execution may often cause the rendering of an animation associated with a visual element to be interrupted prematurely (i.e., before the animation is complete). For example, an event in the executing software may call for the removal of a visual element from a displayed user interface. However, the visual element may have an attached animation that may still be active or an animation that might have become active but for the visual element being discarded. Abruptly halting the animation of the visual element or preventing animations from being rendered as intended may appear as “glitches” or other perceivable distortions in the displayed user interface.

For instance, FIG. 10 illustrates an example of an animation transition 502 that may occur when a first animation 504 in the process of being hidden/destroyed is interrupted by a second animation 506 in the process of becoming visible. An interruption axis 505 graphically depicts this interruption as a dashed vertical line in FIG. 10. Since the two animations 504, 506 may need to address the same object, such as a particular user interface, the second animation 506 may basically interrupt the first animation 504 in this example.

Among a number of properties describing animations 504, 506 that may have a different value for each animation at any given moment in time, the difference in the opacity levels for each of the animations provides a convenient benchmark in this example. As shown in FIG. 10, the difference in the opacity levels for first animation 504 and second animation 506 at the interruption axis 505 may be sufficient to cause a distortion to appear during the transition that occurs when the second animation 506 replaces the first animation 504 that may be displayed on computer display module 160. An example of how animation system 200 described earlier in connection with FIGS. 1-9 may be employed in an attempt to address these scenarios will now be described.

Referring now to FIG. 11, and beginning method 500 at step 510, by way of example only, a software application executing on computer 100 may be configured to use a number of user interfaces for display on computer display module 160. The executing software application may use these user interfaces for a number of reasons, such as for conveying information to users based one or more events occurring during execution. However, the executing software application may be configured for allowing animation system 200 to manage and actually implement these user interfaces on its behalf.

As such, animation system 200 may manage a number of ViewItems 213 that may be used to implement a number of user interfaces on the executing software application's behalf. Layout module 223 in animation system 200 may select one or more ViewItems 213 from Controls UI module 210 for rendering. The particular ViewItems 213 that may be selected can be based on a request from the executing software application identifying the particular ViewItems 213 for example, although the ViewItems 213 may be selected based on other reasons.

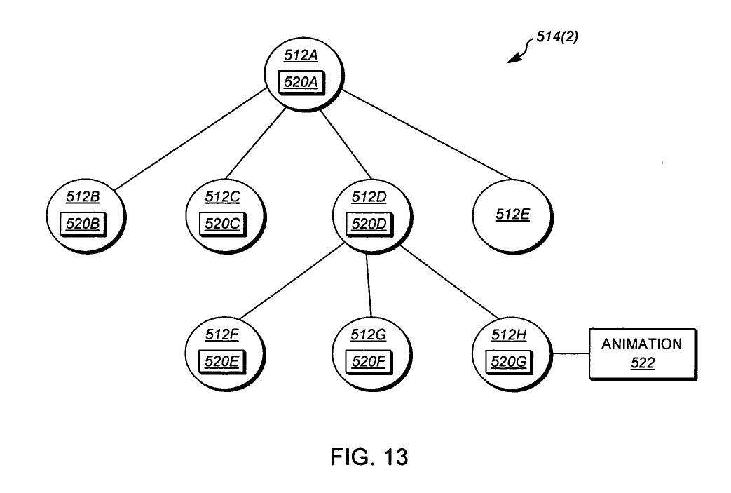

As described above earlier, ViewItems 213 may be logically organized into data structures that may be managed by controls UI module 210, such as tree-like data structures. It should be noted that FIGS. 13, 14, 16 and 17 show one or more objects logically organized into tree-like data structures throughout the ensuing descriptions for exemplary purposes only, as the objects could be organized in any number of other arrangements that may enable animation system 200, for example, to maintain information describing the logical relationships between one or more of the objects.

The ViewItems 213 may be, or may have already been, generated during implementation of method 300 described above in connection with FIG. 3, for example, although the ViewItems 213 may be generated in other ways. Further, one or more Visuals 217 may represent render resources and the basic render units of renderer module 260, which may also be logically organized into data structures that may bear one-to-one relationships with the ViewItems 213, except if it is determined that one or more particular ViewItem will not be rendered as described below in connection with steps 530 and 535, for example. When a ViewItem is not rendered, a Visual may not be generated for that ViewItem.

At step 520, layout module 223 may apply one or more layout constraints on the one or more selected ViewItems before UI framework module 215 generates one or more Visuals for the ViewItems. For example, layout module 223 may determine that a selected ViewItem may be associated with a particular user interface flow layout. Layout module 223 may evaluate the selected ViewItem, including any associated child ViewItems, based on any constraints that may be specified for a particular flow layout defined for the ViewItems.

An example of a layout process will now be described in conjunction with FIG. 12. Layout module 223 may obtain a ViewItem Tree 514(1) comprising a root ViewItem object 512A and several child ViewItem objects 512A-512E from Controls UI module 210, for example. In this example, root ViewItem objects 512A and child ViewItem objects 512A-512E may identify a particular layout in which to render the ViewItems, which is depicted as horizontal layout 516 in FIG. 12 by way of example only. Initially, ViewItem 512A objects may be associated with a Visual object (not shown in FIG. 12) that may be in the process of being rendered by renderer module 260, for example. However, child ViewItems 512B-512E objects may not yet be associated with Visual objects since they may represent newly generated ViewItems.

Layout module 223 may apply one or more constraints and/or any layout instructions associated with horizontal layout 516 on child ViewItem objects 512B-512E. For instance, horizontal layout 516 may represent a layout constraint that may specify a minimum amount of distance between ViewItem objects 512B-512E that may be rendered in the layout. Layout module 223 may then determine if rendered versions of the ViewItems, depicted as ViewItem rendered representations 512B′, 512C′, 512D′, and 512E′ in FIG. 12 by way of example only, may satisfy the constraints represented by horizontal layout 516.

At step 525, if layout module 223 determines that ViewItem objects 512B′, 512C′, 512D′, and 512E′ may not all be rendered together without violating one or more constraints represented by horizontal layout 516, then the NO branch may be followed to step 530. However, if layout module 223 determines that ViewItems 512B′, 512C′, 512D′, and 512E′ may be rendered together without violating one or more constraints in horizontal layout 516, then the YES branch may be followed to step 550.

At step 530, layout module 223 may identify one or more child ViewItem objects 512B-512E shown in FIG. 12 for which a Visual may not be generated or may identify one or more ViewItems whose existing Visuals may be removed to satisfy the layout constraints applied at step 520. In the specific example shown in FIG. 12, initially ViewItem 512E′ may be identified as a ViewItem for which a Visual may not be generated. During one or more subsequent iterations of steps 510-525 in this example, layout module 223 may determine that Visuals may be generated for additional ViewItems that may be added to the Visual tree 514(1), for example, as explained in one or more of steps 535-550 below.

At step 535, if layout module 223 identifies one or more ViewItems at step 530 whose existing Visuals may be removed, then the YES branch may be followed to step 540. Otherwise, if no existing Visuals are identified for removal then the YES branch may be followed to step 560.

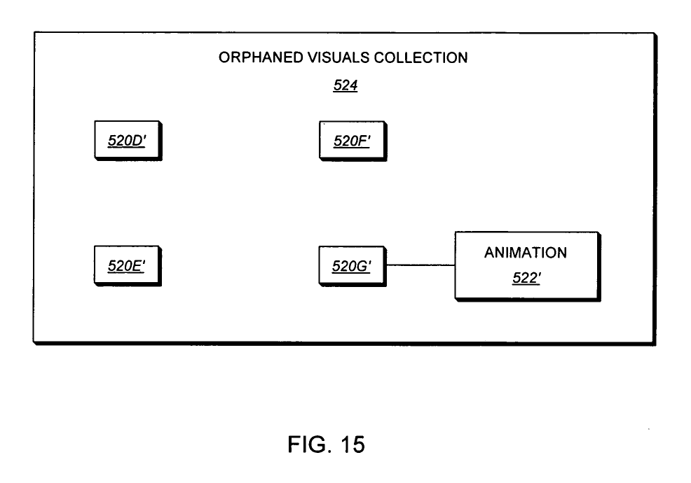

At step 540, one or more of the existing Visuals identified for removal at step 530 may be separately managed by animation system 200 such as in an exemplary orphaned visual collection 524 shown in FIG. 15, for example. The orphaned visual collection 524 may be maintained in computer memory module 150 by animation system 200 and logically organized in any number of data structure arrangements, such as a data base or tree structures for example. Note that initially during a first iteration of steps 510-540, for purposes of this example only with reference to FIG. 13, Visuals 520A-520D may have been generated for ViewItems 512A-512D in a second ViewItem tree 514(2), while no Visual may have needed to have been generated for ViewItem object 512A (nor for ViewItem objects 512F-512H). If there is no existing Visual associated with ViewItem 512A that is being disposed during an initial hypothetical iteration of steps 510-540 in this example, then a Visual need not be placed in an orphaned Visual collection 524 shown in FIG. 15, for instance.

However, and again for exemplary purposes only with continued reference now to FIG. 13, layout module 223 may determine during a subsequent iteration of steps 510-530 that ViewItem objects 512F-512H may be generated as children of ViewItem 512D based on satisfying layout constraints at step 525. Thus, Visuals 520E-520G may be generated for ViewItems 512F-512H, respectively. Further, ViewItem 512H may be associated with an animation 522 that may have been generated in the manner described above in connection with steps 310-340 in method 300 for example. During yet another subsequent iteration of steps 510-530, layout module 223 may determine at step 525 that ViewItem object 512D no longer satisfies the constraints applied at step 520, and may determine that one or more existing Visuals for ViewItems 512D-512H should be disposed of at step 535.

However, one or more of the ViewItems 512D-512H may be associated with one or more animations, such as animation 522 associated with ViewItem 512H in this example. Animation 522 may represent a “Hide” animation that may gradually cause the ViewItem 512H to fade away until no longer visible in the computer display module 160 instead of abruptly removing the interface. Simply discarding any Visuals that may be associated with any such animations may result in disposing of any associated animations as well, and thus may prevent the animation to be rendered as a result. Thus, in this example, a “Hide” animation (e.g., animation 522) that may be associated with ViewItem 512H may not be rendered if the ViewItem's corresponding Visual is prematurely disposed.

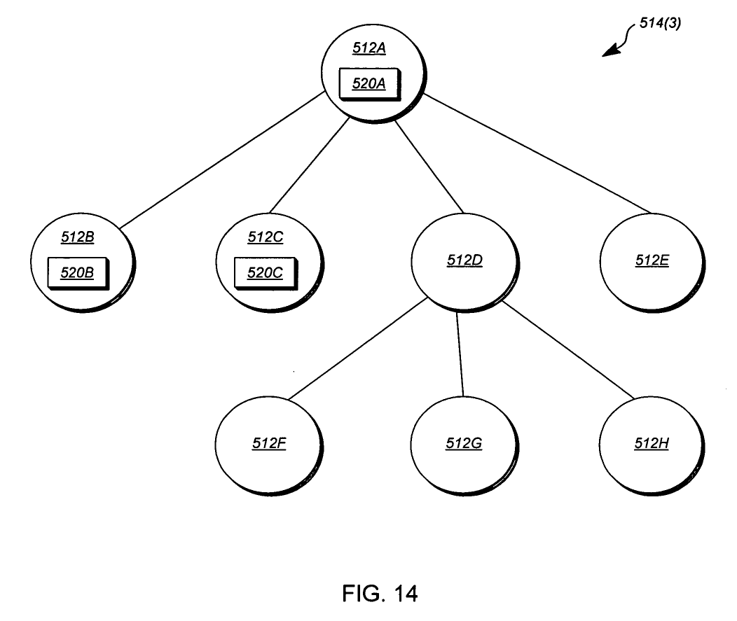

In particular, instead of disposing Visual objects 520D-520G along with any associated animations (e.g., animation 522), animation system 200 may separately manage the Visuals 520D-520G in an orphaned visuals collection 524, for example, which are depicted as orphaned Visuals 520D′-520G′ in FIG. 15 by way of example only. Once the Visual objects 520D-520G in the second ViewItem tree 514(2) are dissociated from their corresponding ViewItem objects 512D, 512F, 512G and 512H, however, the tree 514(2) may be depicted as a third ViewItem tree 514(3) in the manner shown in FIG. 14, for example.

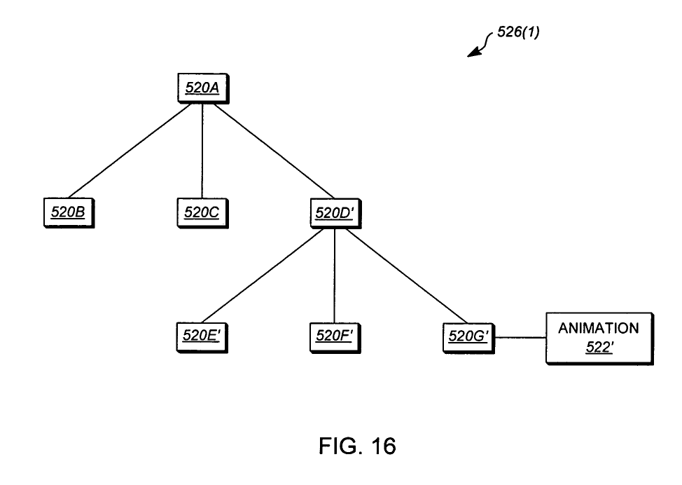

The renderer module 260 may be configured to continue rendering any active orphaned animations associated with any orphaned Visuals 520D′-520G′ which may exist in the orphaned visuals collection 524 shown in FIG. 15, such as orphaned animation 522′, for example, substantively concurrently with any active animations associated with an active rendering Visual object. The third ViewItem tree 514(3) shown in FIG. 14 shows ViewItems objects 512A-512C associated with Visual objects 520A-520E while ViewItems objects 512D-512H are shown as not being associated with any Visual objects. For instance, animation system 200 may associate the orphaned Visual objects 520D′-520G′, which were discarded from the second ViewItem tree 514(2) as explained above, with a first Visual tree 526(1) shown in FIG. 16. One or more Visual objects to be rendered by renderer module 260 may be organized in the first Visual tree 526(1).

The renderer module 260 may continue rendering one or more active animation sequences associated with Visual objects 520A-520C and/or orphaned Visual objects 520D′-520G′ organized in first Visual tree 526(1), for example. Animation system 200 may also monitor the progress of any active orphaned animation sequence associated with one or more orphaned active Visual objects 520D′-520G′, such as orphaned animation 522 to determine when the animation sequence may be complete.

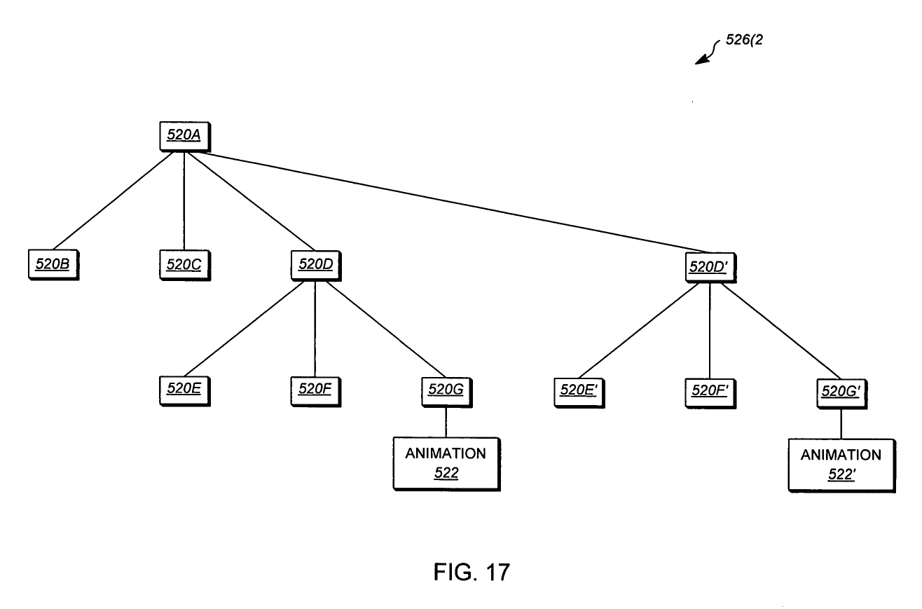

It should be noted that, layout module 223 may also determine at step 525 that one or more Visuals associated with ViewItems that may have been previously disposed of may now be regenerated because their associated ViewItems may now satisfy the layout constraints. For instance, Visual objects 520D-520G, which may have been disassociated from the second exemplary ViewItem tree 514(2) shown in FIG. 13, for example, may be regenerated at step 550. Here, a second exemplary Visual tree 526(2) shown in FIG. 17 with regenerated Visual objects 520D-520G may result.

However, the orphaned Visual objects 520D′-520G′ may be simultaneously maintained with the regenerated Visual objects 520D-520G in the second Visual tree 526(2) shown in FIG. 17. The orphaned Visuals 520D′-520G′ may represent another instance of the Visuals 520D-520G which may enable the renderer module 260 to simultaneously render the animation 522 associated with the original Visual 520G and the orphaned animation 522′ associated with the orphaned Visual 520G′. When the orphaned animation 522′ (e.g., hide animation sequence) associated with the orphaned Visual 520G′ completes, the animation system 200 may dispose of the orphaned Visuals 520D′-520G′, although the Visuals 520D-520G may continue to be rendered.

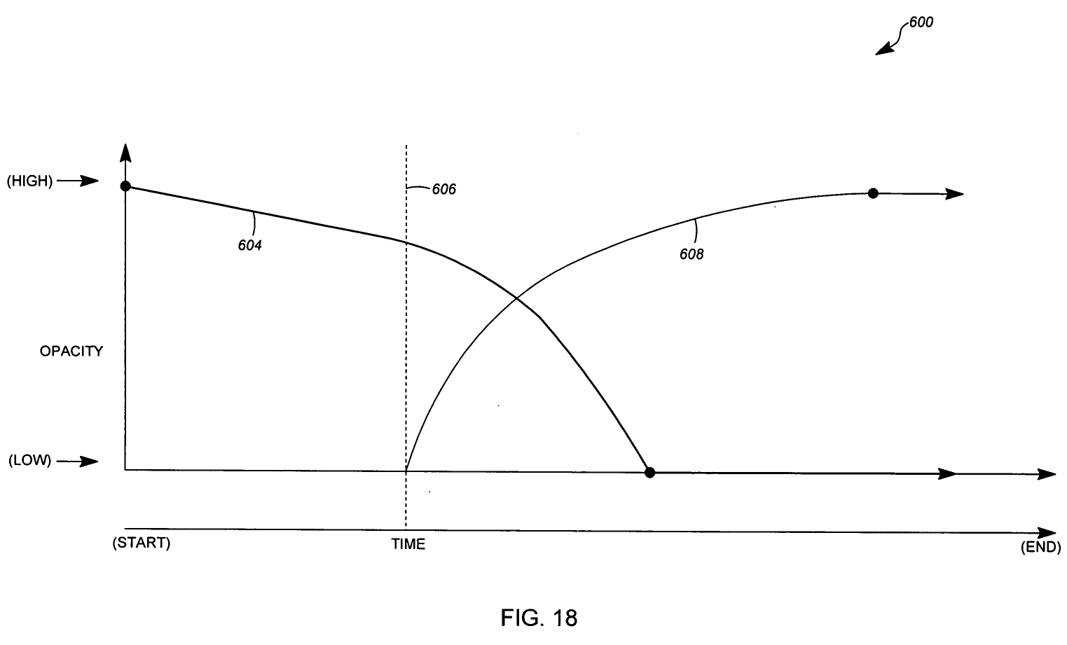

FIG. 18 illustrates an example of an animation transition 600 that may be achieved by employing method 500 to enable a first active animation sequence 604 (e.g., animation 522 from FIG. 17) and a second active animation sequence 608 (e.g., animation 522′ from FIG. 17) to animate substantially simultaneously in substantially the same location of the visible display on computer display module 160 without interrupting each other, for example. By way of example only, a dashed vertical line in FIG. 18 represents an axis 606 graphically depicting a point in time at which the second active animation sequence 608 may begin animating while the first active animation sequence 604 may already be animating. Since the two animations 604, 608 may address two different instances of the same rendering source, for example, both animations may be rendered simultaneously to achieve a cross fade effect—like animation transition that may appear less dramatic compared to the animation transition shown in FIG. 10 discussed above earlier.

At step 550, layout module 223 may generate one or more Visuals for the one or more selected ViewItems in a first exemplary ViewItem tree 514(1) shown in FIG. 12 determined to satisfy the layout constraints at step 525, for example. A second ViewItem tree 514(2) with one or more generated Visual objects 520A-520G is shown in FIG. 13.

At step 560, render module 260 may render any active animation sequences associated with any active Visuals 520A-520G associated with any of the ViewItems 512A-512H in any of the exemplary ViewItem trees 514(1)-514(2), for example, along with any orphaned animation sequences associated with any orphaned Visual objects 520D′-520G′ in any of the Visual trees 526(1) 526(2), for example.

At step 565, if substantially all active animation sequences associated with any of the ViewItem objects 512A-512H in ViewItem trees 514(1)-514(3) have completed animating, then the YES branch may be followed to step 570. However, if one or more active animation sequences in ViewItem trees 514(1)-514(3) remain to be animated, then the NO branch may be followed back to step 510, for example, to repeat at least one other iteration of at least a portion of the method 500.

At step 570, if all of the active animation sequences associated with any orphaned Visuals have completed animating, such as animation 522 and orphaned animation 522′ in the second visual tree 526(2) shown in FIG. 17, for example, then the YES branch may be followed and the method 500 may end. However, if any active animation sequences associated with any orphaned Visuals are still animating, then the NO branch may be followed back to step 510, for example, to repeat at least one other iteration of at least a portion of the method 500.

While the computer memory module 150 illustrated in FIG. 1 is described as comprising computer storage media, it should be appreciated that the memory module 150 should be broadly interpreted to cover communication media as well. Communication media may embody computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example only, communication media includes wired media, such as a wired network or direct-wired connection, and wireless media, such as acoustic, RF, infrared, other wireless media, and combinations thereof.

It should also be appreciated that storage devices utilized to store program instructions may be distributed across one or more networks. For example, one or more first networked computer systems may store one or more computer readable/executable instructions as software embodying one or more portions of the process(es) described above when executed in cooperation. Further, one or more second networked computer systems may access the first networked computer systems to download at least a portion of the software for execution by the second networked computer systems to implement one or more portions of the above-described process(es). Alternatively or in addition, the second networked computer systems may download one or more portions of the software as needed and/or the first and second networked computer systems may execute one or more portions of the software instructions.

Furthermore, while particular examples and possible implementations have been called out above, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefore, is not intended to limit any claimed process(es) to any order except as may be explicitly specified in the claims.

What is claimed is:

1. At least one computer-readable medium having at least one instruction stored thereon, which when executed by at least one processing system, causes the at least one processing system to implement a user interface animation system, the at least one stored instruction comprising:
one or more orphaned rendering objects that are dissociated from one or more current rendering objects by a user interface animation system in response to one or more events; and
at least one active animation object associated with the one or more orphaned rendering objects whose animation instructions are executed until substantially complete.

2. The medium of claim 1 wherein the one or more events comprise the one or more orphaned rendering objects no longer actively being utilized by at least one software application or a layout module determining that the one or more orphaned rendering objects do not satisfy one or more current layout constraints.

3. The medium of claim 1 wherein the one or more current rendering objects and the one or more orphaned rendering objects are associated with one or more user interface objects generated for at least one software application.

4. The medium of claim 1 wherein the one or more current rendering objects and the one or more orphaned rendering objects represent actual rendering resources utilized by a rendering module to be generated for display using a computer display device.

5. The medium of claim 1 wherein the one or more orphaned rendering objects comprise an instance of one or more corresponding current rendering objects.

6. The medium as set forth in claim 1 wherein the at least one animation instruction in the at least one animation object implement one or more animation sequences for manipulating an associated user interface object.

7. The medium as set forth in claim 1 wherein the one or more animation sequences comprise at least one of either a show animation, hide animation, move animation, size animation, focus animation, or any other animation that manipulates one or more properties of the associated user interface object.

8. The medium as set forth in claim 7 wherein the one or more properties of the associated user interface object comprise at least one of either a position property, a size property, a scale property, a rotation property, an opacity property and/or a color property.

9. An animation transitioning method for enabling animations associated with disposed rendering objects to continue animating, the method comprising:
selecting one or more current rendering objects for disposal based on one or more layout constraints;
identifying the current rendering objects selected for disposal that are associated with one or more active animation sequences; and
managing the identified current rendering objects selected for disposal in an orphaned rendering object collection to enable the one or more associated active animation sequences to continue animating despite their discarded status.

10. The method as set forth in claim 9 further comprising monitoring the one or more managed rendering objects in the orphaned rendering object collection to determine whether the one or more associated active animation sequences have substantially completed.

11. The method as set forth in claim 10 further comprising removing the managed rendering objects whose associated animations have substantially completed from the orphaned rendering object collection.

12. The method as set forth in claim 9 further comprising rendering one or more current active animation sequences and one or more orphaned animation sequences associated with the one or more managed rendering objects.

13. The method as set forth in claim 9 wherein the animations comprise at least one of either a show animation, hide animation, move animation, size animation, focus animation, or any other animation that manipulates one or more properties of an associated user interface object.

14. The method as set forth in claim 9 wherein the one or more properties of an associated user interface object comprise at least one of either a position property, a size property, a scale property, a rotation property, an opacity property and/or a color property.

15. At least one computer-readable medium having at least one instruction stored thereon, which when executed by at least one processing system, causes the at least one processing system to implement a user interface animation system, the at least one stored instruction comprising:
a first group of one or more user interface objects associated with one or more current rendering objects to be rendered by a rendering module;
one or more animation objects associated with one or more of the user interface objects in the first group having at least one animation instruction for implementing at least one animation sequence involving the one or more associated user interface objects; and
a second group of one or more user interface objects that are not associated with one or more current rendering objects to be rendered by the rendering module but are associated with one or more orphaned rendering objects that are associated with at least one active orphaned animation object separately managed by the user interface animation system.

16. The medium as set forth in claim 15 wherein at least one of either the one or more animation sequences or the at least one active orphaned animation object comprise at least one of either a show animation, hide animation, move animation, size animation, focus animation, or any other animation that manipulates one or more properties of the one or more associated user interface objects.

17. The method as set forth in claim 16 wherein the one or more properties of the associated user interface objects comprise at least one of either a position property, a size property, a scale property, a rotation property, an opacity property and/or a color property.

18. The medium as set forth in claim 15 wherein the one or more orphaned rendering objects were current rendering objects associated with one or more of the user interface objects in the second group substantially until being discarded by the user interface animation system from the second group in response to one or more events.

19. The medium as set forth in claim 18 wherein the one or more active orphaned animation objects associated with the one or more orphaned rendering objects execute until substantially complete.

20. The medium as set forth in claim 19 wherein the one or more orphaned rendering objects are disposed of by the user interface animation system when the executing animation objects are substantially complete.
